(19) United States
(12) Patent Application Publication
(10) Pub. No.: US 2010/0042326 A1
(43) Pub. Date: Feb. 18, 2010

(54) METHOD OF DETECTING A LATERAL BOUNDARY OF A RESERVOIR

(76) Inventors: Stephen James Bourne, Rijswijk (NL); Paul James Hatchell, Rijswijk (NL)

Correspondence Address: SHELL OIL COMPANY, P O BOX 2463, HOUSTON, TX, 772522463, US

(21) Appl. No.: 12/445,603

(22) PCT Filed: Oct. 16, 2007
(86) PCT No.: PCT/EP07/61043

§ 371 Date: Apr. 15, 2009

(30) Foreign Application Priority Data
Oct. 16, 2006 (EP) 06122368.1
Oct. 16, 2006 (EP) 06122372.3

(51) Int. Cl. G06F 19/00; G01V 11/00; E21B 43/00

(52) U.S. Cl. 702/11; 166/369; 702/14

(57) ABSTRACT

A method of monitoring a subsurface formation underneath a sea bed, the method comprising determining non-vertical deformation of the sea floor over a period of time and inferring a parameter related to a volume change in the subsurface formation from the non-vertical deformation of the sea. Determining the non-vertical deformation of the sea floor comprises selecting a plurality of locations on the sea floor and determining a change in distance between at least one pair of the locations over the period of time.

### FIELD OF THE INVENTION

The present invention relates to a method of monitoring a subsurface formation underneath a sea bed, and to a method for producing hydrocarbons.

### BACKGROUND OF THE INVENTION

Offshore production of hydrocarbons (oil and/or natural gas) from subsea reservoirs remains a challenging operation. There is a need for technologies that allow monitoring of volume change in the subsurface formation including the reservoir. Such a volume change can be compaction, typically due to production of hydrocarbons from the reservoir, but also extension, such as due to injection of a fluid (e.g. water, gas) into the formation.

U.S. Pat. No. 6,813,564 discloses a method and system for monitoring subsidence of the sea floor as an alternative for well measurements or repeated seismic measurements to monitor hydrocarbon reservoir changes. In US '564, pressure and gravity sensors at the sea floor are used to monitor depth changes.

Sea floor subsidence is difficult to measure with sufficient accuracy due to tidal effects, waves, temperature effects in the water column, and due to long-term stability problems of pressure sensors. There is a need for an alternative or complementary method of monitoring a subsurface formation underneath a sea bed.

### SUMMARY OF THE INVENTION

To this end the present invention provides a method of monitoring a subsurface formation underneath a sea bed, which method comprises

determining non-vertical deformation of the sea floor over a period of time; and

inferring a parameter related to a volume change in the subsurface formation from the non-vertical deformation of the sea bottom.

Applicant has realized that non-vertical displacement, and in particular displacement in the horizontal plane, is very sensitive to subsurface volume changes and has several advantages over vertical displacement or subsidence. Direct measurement of the displacement by sensors on the sea floor is far less influenced by tidal effects, waves, and temperature effects in the entire water column. Contrary to intuition, the magnitude of horizontal displacements is comparable to the vertical displacements. In fact complementary signatures of subsurface volume changes to those from vertical displacements can be obtained from horizontal displacements.

In one embodiment, determining non-vertical deformation of the sea floor comprises selecting a plurality of locations on the sea floor and determining the change in distance between at least one pair of the locations over the period of time. At each such location a sensor can be installed, permanently or periodically, and the distance between a pair of sensors at an initial time and at a later point in time can be compared. Preferably sensors are arranged in a grid or along a line. This allows mapping of displacements in a monitoring zone on the sea floor, and also distance measurements from one location to a plurality of other locations.

The expression ‘sensor’ is used herein to refer to any device used in determining a change of its location, and includes for example acoustic or electric transmitters, receivers, transceivers, transponders, transducers; tilt meters, pressure gauges, gravity meters, etc.

The distance can for example be determined by means of acoustic transmitters/receivers placed at the plurality of locations, or by means of a fibre optic strain sensor coupled at a plurality of locations to the sea floor.

It can be advantageous to measure vertical displacement of the seafloor over the same period of time. In particular, depth sensors such as pressure or gravity sensors can be arranged at the same locations as for measuring non-vertical displacement. In case the vertical displacement is available as well, a relationship such as a ratio between horizontal and vertical displacements at a selected point, or more points if available, can be determined and used to estimate the lateral position of a centre of compaction or expansion in the subsurface formation.

From the monitoring of the non-vertical displacement several parameters about the subsurface formation can be inferred. The compaction or expansion of the region in the subsurface formation can be studied directly, e.g. a local compaction of expansion as a function of lateral position can be determined, e.g. through inversion of a surface deformation map. The depletion or accumulation of fluids in different subsurface regions can be derived, and if a plurality of fluid filled regions in the subsurface formation, the fluid connectivity between them can be studied. Moreover, lateral edges of regions undergoing a volume change can be detected and localized. Another application is the assessment of the risk of fault reactivation by measuring different rates of reservoir compaction or dilatation on either side of a fault. This allows for example to avoid drilling infill wells through faults that have been identified to be at increased risk of re-activation. Suitably, a lateral distribution of the parameter is determined.

The invention can advantageously be used in combination with seismic surveying the subsurface formation, in particular time-lapse seismic monitoring. When a base seismic survey of the subsurface formation is available the method can comprise

postulating a threshold condition related to a minimum volume change in the subsurface formation, under which a repeat seismic survey of the subsurface formation is expected to be sensitive; and

monitoring the non-vertical deformation of the sea-floor to determine when the threshold condition is met. Because the non-vertical displacement can be more sensitive to subsurface volume changes, it can be used to determine the optimum time for a repeat seismic survey.

In a typical application of the invention the subsurface formation comprises a fluid reservoir, and the volume change takes place in the course of production of fluid from or injection of a fluid into the hydrocarbon reservoir. This can be production of hydrocarbons such as oil or natural gas, but also water, or the injection of a production-enhancing fluid such as water or gas, or the storage of a fluid such as carbon dioxide. A particular important application is the monitoring of depletion of a reservoir region, preferably mapping local depletion laterally over the reservoir region.

Advantageously the non-vertical deformation can be interpreted using a geomechanical and/or reservoir model of the subsurface formation.

There is also provided a method for producing hydrocarbons from a subsurface formation underneath a sea bed, wherein the subsurface formation is monitored by the method of monitoring a subsurface formation underneath a sea bed.

### BRIEF DESCRIPTION OF THE DRAWINGS

An embodiment of the invention will now be described in more detail and with reference to the accompanying drawings, wherein

FIG. 1 shows schematically the vertical displacement (1a), horizontal displacement (1b), and horizontal strain (1c) in the subsurface due to a compacting subsurface region;

FIG. 2 shows a model calculation of the vertical and horizontal displacement at the sea floor, for various sizes of compacting subsurface regions;

FIG. 3 shows schematically two arrangements of sensors on the sea floor.

Where the same reference numerals are used in different Figures, they refer to the same or similar objects.

### DETAILED DESCRIPTION OF THE INVENTION

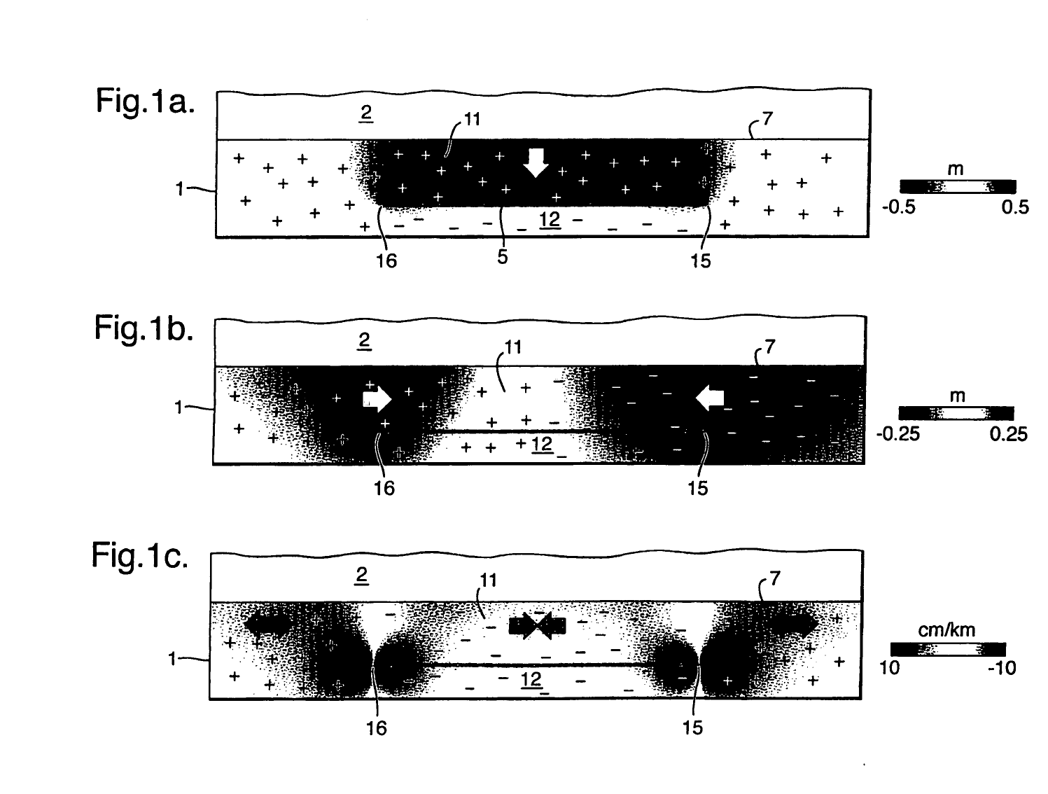

Reference is made to FIG. 1. FIG. 1 shows three pictures of a vertical cross-section through a subsurface formation 1 underneath a sea bed 2. A reservoir layer 5 is present at a distance under the sea floor 7.

FIG. 1 displays the results of a geomechanical modelling of the subsurface formation 1. The used model is based on a homogeneous isotropic linear poro-elastic half-space extending downwardly from the sea floor, and containing a block-shaped reservoir subject to a uniform reduction in pore fluid pressure. The pore pressure change was selected to achieve a maximum of 1 m of compaction inside the reservoir. The shear modulus is 1 GPa and the Poisson's ratio is 0.25. We note the following conclusions drawn from these solutions are independent of the choice of shear modulus and Poisson's ratio.

All pictures in FIG. 1 show shading. The shading scale is given at the right hand side, and the areas of positive and negative values are indicated by “+” and “−” respectively.

The top picture, FIG. 1a, is shaded according to vertical displacement in response to a compaction of the reservoir, such as due to depletion by production of hydrocarbons from the reservoir through a well (not shown). Subsidence is counted as positive displacement. The strongest subsidence is observed in the overburden 11 just above the compacting reservoir. The sea floor 7 subsides strongest above the centre of the reservoir. The example also shows uplift in the underburden 12.

The middle picture, FIG. 1b, maps the horizontal displacement in the subsurface formation 1 and on the sea floor 7 in the paper plane. Displacement to the right is counted positive. It was realized that a volume decrease of a subsurface reservoir does not only lead to vertical compaction, but is typically accompanied by a horizontal contraction of the reservoir. The contraction is minimum in the centre and strongest towards the lateral edges of the reservoir. As a result, contraction is also visible on the sea floor as a deformation. The contraction on the sea floor is strongest at and above the lateral edges 15, 16 of the reservoir layer.

The bottom picture, FIG. 1c, displays strain in the subsurface formation, which is calculated as the derivative of the displacement in the middle picture with respect to the horizontal (x) co-ordinate in the paper plane. Elongation strain is counted as positive. It is found that the strain changes sign from compressive to dilatative, approximately above the lateral edges of the reservoir.

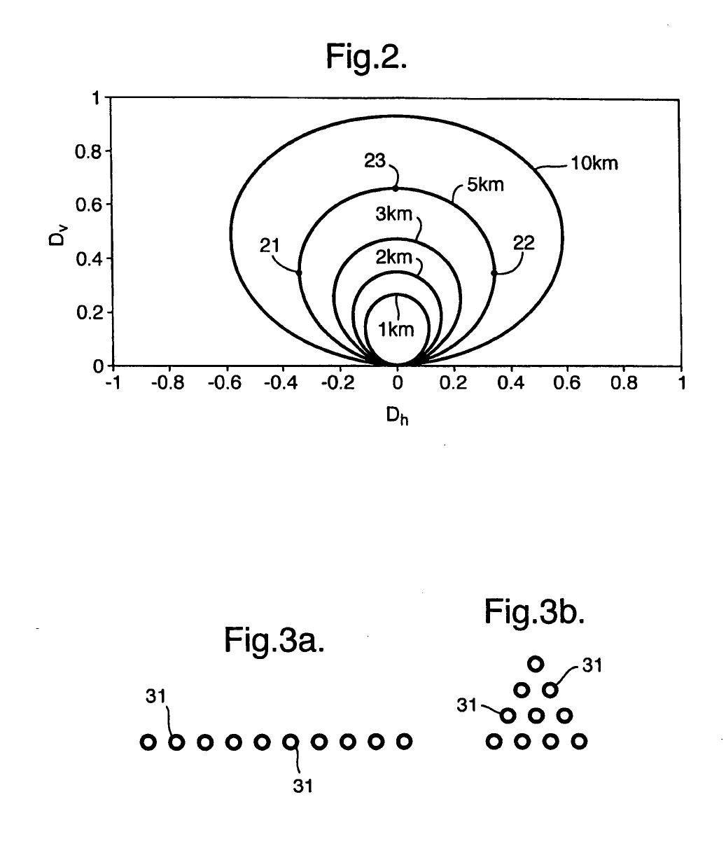

FIG. 1 demonstrates, that horizontal displacement of the sea floor carries complementary information to vertical displacement. This will be further discussed with reference to FIG. 2. FIG. 2 shows the relationship between vertical and horizontal displacement at the sea floor for various sizes of the reservoir layer of FIG. 1. A square block shaped reservoir with horizontal extents x by x is considered, where x is denoted in FIG. 2. The thickness of the reservoir is small compared to its horizontal extent, i.e. <100 m. The reservoir is subject to a unit reduction in thickness due to depletion. Horizontal and vertical displacements of the surface are expressed as fractions of this unit reduction in reservoir thickness. The reservoir is contained within an isotropic homogeneous linear elastic half-space extending downwardly from the sea floor, and having a Poisson ratio of 0.25.

Each point on a curve in FIG. 2 represents the horizontal and vertical displacement of a certain location on the sea floor. The point at Dᵥ=Dₕ=0 corresponds to a location far away from the reservoir, such as at the far left of FIG. 1. If one approaches the reservoir, horizontal and vertical displacements become more and more noticeable. Above the lateral edges of the region a maximum absolute horizontal displacement Dₕ is reached, e.g. for the 5 km example at point 21 (corresponding to the edge 15 in FIG. 1) and at point 22 (edge 16). The maximum subsidence Dᵥ is found at 23 above the centre of the reservoir region, and Dₕ is zero there.

It becomes clear that the maximum horizontal displacement at the sea floor level is of the same order of magnitude as the maximum vertical displacement, and that their maximum is in the same order of magnitude as the compaction or expansion of the subsurface region, in particular for large reservoirs, having a lateral extension in the order of or larger than the depth below the sea floor.

Contraction corresponds to negative strain, and therefore maximum contraction corresponds to the local minima in the value of strain induced at the surface. The maximum magnitude of horizontal contraction of the earth's surface due to compaction of the reservoir is approximately equal to u/(3πd), where u is the reservoir compaction and d is the depth of the reservoir. The ratio of maximum horizontal elongation to maximum horizontal contraction of the earth's surface for a unit compaction (1 m) is 1+3πd/w, where w is the width of the depleting reservoir.

In the Figures a compacting reservoir has been discussed, it will be clear that the case of an expanding subsurface region has an opposite (qualitatively a change of sign for displacements and strains), but otherwise analogous, signature.

Examples will now be discussed how the non-vertical deformation of the sea floor can be determined.

In FIGS. 3a and 3b two arrangements of a measurement network on the sea floor are sketched. At each location 31 an acoustic transmitter and/or receiver is arranged, suitably a transponder responding by an acoustic signal to a signal it receives from another transponder. Suitable acoustic transponders are for example manufactured by Sonardyne International Limited of Yateley, UK, and these are typically used for positioning of equipment on the sea floor.

By a linear arrangement as in FIG. 3a, an extended one-dimensional horizontal displacement profile can be measured, as e.g. in FIG. 1. The grid of FIG. 3b allows mapping of the displacement in two dimensions. Also, distances from one of the locations 31 to several nearest neighbours and further neighbours can be determined, which allows to carry out consistency checks so as to increase the overall accuracy of measurements. Of course other grids are possible as well, and it is not required to adhere to a regular grid. More or less transponders can be installed.

A suitable distance between locations of adjacent transponders on the sea floor is from 10 to 100% of the reservoir depth, preferably between 20 and 60%, such as 40% of reservoir depth.

Using a pair of acoustic transponders an acoustic travel time can be determined, which can be converted to a distance between the respective locations using the speed of sound in sea water. Preferably, sound speed sensors are arranged on the sea floor as well, such as one at each transducer location, to be able to take fluctuations due to e.g. temperature or salinity changes into account, thereby increasing accuracy of the measurements.

Subsea transponders preferably operate wireless and are suitably equipped with batteries that allow extended operation of many months, preferably several years. Data, can be stored for days, weeks or months, and transmitted to a transducer on a buoy, ship, or platform. Because the underlying deformation is slow, in the order of few cm/year at maximum, an acoustic transducer network does not need to operate continuously which saves battery life. The transponders can be permanently installed, but also periodical installation at pairs of locations is possible, carried out by a remotely operated vehicle for example. A permanent installation is preferred, however, since repositioning errors are circumvented in this way. This is in fact an advantage of acoustic lateral measurements over subsidence measurements by pressure sensors, which have insufficient long-term stability for accurate measurements in a permanent installation over periods of months, and need therefore regular calibration for which they are typically removed from the sea floor.

Alternatively, fibre optic strain sensors can be used for measurement of the non-vertical sea-floor deformation. Such sensors are for example manufactured by Sensornet Ltd. of Elstree, UK. A fibre optic strain sensor can monitor strain over extended distances of kilometres, and a strain profile with a measurement spacing of about 1 m can be obtained. The sensor cable is to be anchored to the sea floor to provide sufficient coupling.

Another measurement option is through repeated imaging, such as sonar imaging, from moving vehicles with precise positioning.

Advantageously, vertical displacement is monitored as well. In a sea floor installation for monitoring deformation, suitably sensors for detecting vertical displacement are included as well, such as pressure and/or gravity sensors. It becomes clear from FIG. 2 that complementary information can be obtained from horizontal and vertical displacement. For example, the maximum horizontal displacement is observed above the lateral edges of the reservoir, and the ratio of vertical to horizontal displacement is a very sensitive indicator of the centre of the compacting or expanding reservoir, as vertical displacement is maximum there and horizontal displacement substantially zero.

The invention is very useful to obtain insight into the compaction or expansion of a region in the subsurface formation can be studied. Detailed insight can be gained from an inversion of a surface deformation map. A distribution of local reservoir volume changes can for example be obtained using a method of least-squares inversion including the following steps:

1. Represent the reservoir as a collection of blocks (i) (i=1, . . . , M), distributed to represent the reservoir geometry and limited to block sizes no larger than 10% of the depth, and select a plurality of surface locations (j) (j=1, . . . , N).

2. Use either a known analytical solution or a numerical solution to obtain the component of measured deformation at surface location (j) in response to a unit compaction or dilation of reservoir grid block (i). Repeat to obtain a system of equations and hence a matrix of coefficients for every i-j combination. The system of equations is typically linear, due to the linearity of Hookes's law, which is usually applicable for small incremental deformations (i.e. strains<10%) such as those considered here.

3. Add to this system of equations additional terms for zero or second order regularisation of the solution.

4. Solve using the method of non-negative least squares.

Details about inversion methods can for example be found in the book “Inverse Problem Theory” by Albert Tarantola, Society for Industrial and Applied Mathematics, 2005.

Monitoring of volume change is desirable in the course of production of fluid (e.g. hydrocarbon oil, natural gas, and/or water) from, or injection of a fluid (e.g. gas, water, steam and/or chemicals) into the fluid reservoir, but it can also be due to a change in temperature or temperature distribution in the subsurface formation such as due to heating of the subsurface formation. From a detailed knowledge of the distribution of local volume changes throughout a reservoir region, insight into e.g. depletion and in particular deviations from a uniform depletion can be obtained. Maps such as a depletion map or a temperature difference map can be determined.

A known technique to monitor effects due to volume changes in the subsurface is time-lapse seismic surveying. In time-lapse seismic surveying, seismic data is acquired at least two points in time, to study changes in seismic properties of the subsurface as a function of time. Time-lapse seismic surveying is also referred to as 4-dimensional (or 4D) seismics, wherein time between acquisitions represents a fourth data dimension.

A general difficulty in seismic surveying of oil or gas fields is that the reservoir region normally lies several hundreds of meters up to several thousands of meters below the earth's surface, but the thickness of the reservoir region or layer is comparatively small, i.e. typically only several meters or tens of meters. Sensitivity to detect small changes in the reservoir region is therefore an issue, in particular vertical resolution. Present technology can typically detect a compaction of a reservoir region by approximately 20 cm. Proper timing of a repeat survey is important. If done too early, the resolution is not sufficient for valid conclusions, but by waiting too long one may miss opportunities to optimise production of hydrocarbons from the reservoir region.

The information obtainable about subsurface volume changes from time-lapse seismic surveying and monitoring of sea floor deformation can be regarded as complementary. For large reservoirs, the subsidence at the centre of the reservoir is approximately equal to the subsidence of the top reservoir horizon. Therefore, there is little change in the stress field in the overburden, so that time-lapse seismic will show little change, since time-lapse timeshifts measured at the top reservoir, are proportional to the difference between displacements at the top reservoir and the earth's surface. As is visible from FIG. 2, however, for large reservoirs there is a large horizontal deformation on the sea floor, so the present invention is particularly sensitive. A large reservoir is a reservoir that has a lateral extension about equal to its depth, or larger.

FIG. 2 also shows that the horizontal deformation on the sea floor is less for a small reservoir, having a lateral extension of less than its depth. In such a case, however a volume change in the reservoir region causes a significant change in the stress field around the reservoir. It is known from International Patent Application No. WO2005/040858 that time-lapse seismic measurements are well suited to study such changes in the stress field, for example the two-way travel time to the top reservoir event is influenced by the stress field in the overburden.

Monitoring non-vertical sea floor deformation is possible with an accuracy of 1 cm per km distance on the sea floor. As can be deduced from FIG. 2, with such an accuracy it is possible to detect reservoir compaction by 10 cm or less, in particular 5 cm or less, for example even 2 cm. For comparison, assume that a compaction by 10 cm is for example achieved in 6-18 months of production from a reservoir region, and in this case it is possible with the new method to follow depletion on a time scale of months.

The non-vertical deformation of the sea floor that is determined is preferably a near-horizontal deformation, in particular within 45 degrees from the horizontal, preferably within 30 degrees from the horizontal.

1. A method of monitoring a subsurface formation underneath a sea bed, the method comprising:
determining non-vertical deformation of the sea floor over a period of time; and
inferring a parameter related to a volume change in the subsurface formation from the non-vertical deformation of the sea bottom;
wherein determining non-vertical deformation of the sea floor comprises:
selecting a plurality of locations on the sea floor; and
determining a change in distance between at least one pair of the locations over the period of time.

2. (canceled)

3. The method according to claim 1, wherein the change in distance is determined by means of sensors placed at the plurality of locations, in particular acoustic transmitters/receivers.

4. The method according to claim 1, wherein the non-vertical deformation is determined by means of a fibre optic strain sensor coupled at a plurality of locations to the sea floor.

5. The method according to claim 1, further comprising: measuring vertical displacement of the seafloor over the period of time.

6. The method according to claim 5, further comprising: determining a relationship between horizontal and vertical displacements at a selected point on the sea floor and using this relationship to estimate the lateral position of a centre of compaction or expansion in the subsurface formation.

7. The method according to claim 1, wherein the parameter inferred relates to at least one of compaction or expansion of a region in the subsurface formation, location of a lateral edge of a subsea region undergoing volume change, depletion of a reservoir region in the subsurface formation, fluid connectivity between a plurality of regions in the subsurface formation, risk of fault reactivation, risk of well failure.

8. The method according to claim 1, wherein a lateral distribution of the parameter is determined.

9. The method according to claim 1, wherein a base seismic survey of the subsurface formation is available, and wherein the method further comprises
postulating a threshold condition related to a minimum volume change in the subsurface formation, under which a repeat seismic survey of the subsurface formation is expected to be sensitive; and
monitoring the non-vertical deformation of the sea-floor to determine when the threshold condition is met.

10. The method according to claim 1, wherein the subsurface formation comprises a fluid reservoir, and wherein the volume change takes place in the course of production of fluid from or injection of a fluid into the fluid reservoir

11. The method according to claim 1, wherein depletion of the reservoir during production of fluid is monitored.

12. The method according to claim 1, wherein the non-vertical deformation at the sea floor is interpreted using a geomechanical and/or reservoir model of the subsurface formation.

13. A method for producing hydrocarbons from a subsurface formation underneath a sea bed, wherein the subsurface formation is monitored by the method of claim 1.
